(19) United States
(12) Patent Application Publication
(10) Pub. No.: US 2014/0354390 A1
(43) Pub. Date: Dec. 4, 2014

(54) TAP CHANGER

(71) Applicants: Stefan Engel, Aachen (DE); Jochen Von Bloh, Aachen (DE); Dieter Dohnal, Lappersdorf (DE); Karsten Viereck, Regensburg (DE); Rik W. De Doncker, Leuven (BE)

(72) Inventors: Stefan Engel, Aachen (DE); Jochen Von Bloh, Aachen (DE); Dieter Dohnal, Lappersdorf (DE); Karsten Viereck, Regensburg (DE); Rik W. De Doncker, Leuven (BE)

(21) Appl. No.: 13/978,810

(22) PCT Filed: Feb. 6, 2012
(86) PCT No.: PCT/EP2012/051962

§ 371 Date: Sep. 17, 2013

(30) Foreign Application Priority Data
Feb. 23, 2011 (DE) 10 2011 012 080.7

(51) Int. Cl. H01F 29/04

(52) U.S. Cl. CPC H01F 29/04
USPC 336/150

(57) ABSTRACT

The invention relates to a tap changer for voltage regulation, comprising semiconductor switch units (S1.1, . . . , S1.6; S2.1, . . . , S2.6) on a variable transformer having a regulating winding, wherein two parallel load branches (1, 2) are provided, in each of which several series-connected semiconductor switch units are arranged. Parts of the regulating winding (W1, W2, W3) and bridges (B1, B2) are provided alternately and run parallel between the two load branches, alternating such that by corresponding connection of the semiconductor switch units in both load branches, the parts of the regulating wiring can be operated arbitrarily in a subtractive and/or additive manner.

The invention relates to a tap changer for voltage regulation with semiconductor switching elements.

DE 22 48 166 [U.S. Pat. No. 4,220,911] already describes a regulable transformer with semiconductor switching elements. In that case, the secondary winding consists of a specific number of regulating winding parts that are combined into a defined number of winding groups connected in series, wherein each winding group contains two or three regulating winding parts connected in parallel. In that case, each regulating winding part is provided with a contactless switching element. Also described in this specification is another variant, in which the secondary winding of the transformer consists of a group of regulating winding parts connected in series, wherein each regulating winding part contains four contactless switching elements. The arrangement is designed in such a manner that the direction of the voltage at the terminals of the regulating winding part is reversible and also the entire regulating winding part can be selectably bridged over.

A further device for stepped switching of the secondary voltage of a transformer is known from DE 25 08 013 [U.S. Pat. No. 3,973,395].

In this regard as well the secondary winding is grouped into sub-windings, wherein semiconductor switching elements for switching over can similarly be provided.

DE 197 47 712 describes an arrangement of a tap changer of similar kind to a tapped transformer constructed as an autotransformer. In that regard, individual winding parts that are connectable individually and independently of one another are similarly provided. Apart from fixed taps of the regulating winding, in this arrangement separate winding parts can be additionally switched on or connected.

Different forms of embodiment of a further tap changer for uninterrupted load changeover are known from WO 9527931 [U.S. Pat. No. 5,604,423], where thyristors similarly serve as switching elements. In that case, different winding parts of a tap winding as part of the secondary winding of the respective tapped transformer can be connected or disconnected by means of thyristor pairs in anti-parallel connection. In addition, for realization of a voltage regulation that is as finely stepped as possible, with a limited number of winding taps there is proposed in this specification a method that is termed “discrete circle modulation” and in which the thyristors are controlled in such a manner that intermediate values of the secondary voltage result.

In the solutions known from the prior art semiconductor switching elements de facto take over the function of the mechanical selector arm in classic mechanical tap changers. Individual winding taps of the regulating windings can themselves be connected or disconnected by means of the semiconductor switching elements. It is also possible to subdivide the regulating winding into sub-windings that can be separately connected.

The high level of circuit complication and the necessary special adaptation of the semiconductor switching elements are disadvantageous in this prior art.

A further disadvantage of the prior art is that regulation is no longer possible or at least adequate regulation is no longer possible in the event of failure of individual semiconductor switching elements.

It is object of the invention to indicate a tap changer with semiconductor switching elements that is of simple construction. In addition, it shall have a modular, expandable construction. Finally, the tap changer according to the invention shall have a high level of regulating reliability and accuracy even in the case of failure of individual switching elements, quasi as emergency operation.

This object is fulfilled by a tap changer with the features of the first claim. The subclaims relate to particularly advantageous developments of the invention.

The general inventive idea consists in constructing the tap changer in modular manner and selectively connecting and connecting in opposition different sub-windings of the regulating winding.

The tap changer according to the invention comprises two parallel switching branches that each comprise semiconductor switching units connected in series. The individual semiconductor switching units of the first load branch and the individual is semiconductor switching units of the second load branch respectively lie opposite one another in pairs. Electrical sub-windings of the regulating winding are provided in parallel between the two load branches, in each instance between two semiconductor switching units of each load branch. The electrical sub-windings are respectively magnetically coupled with the regulating winding, i.e. mounted on the respective transformer arm.

The electrical sub-windings can be connected or connected in opposition as desired by the respective switching states of the semiconductor switching units in the two load branches.

With particular advantage the electrical sub-windings are differently dimensioned. If a first sub-winding has a specific number of windings, the other electrical subwindings have winding numbers that represent a multiple.

It is possible within the scope of the invention to vary the number of the individual semiconductor switching units as well as the electrical sub-windings that in total form the tap changer according to the invention.

In the case of the tap changer according to the invention a large number of voltage steps is achievable with only a few components for selective connecting or connecting in opposition of the individual sub-windings. Moreover, in the tap changer according to the invention a redundant generation of individual sub-voltages is possible; in the case of failure—which can never be excluded in practice—of individual switching elements the regulation can nevertheless be substantially continued.

The invention shall be explained in more detail in the following by way of example on the basis of drawings, in which:

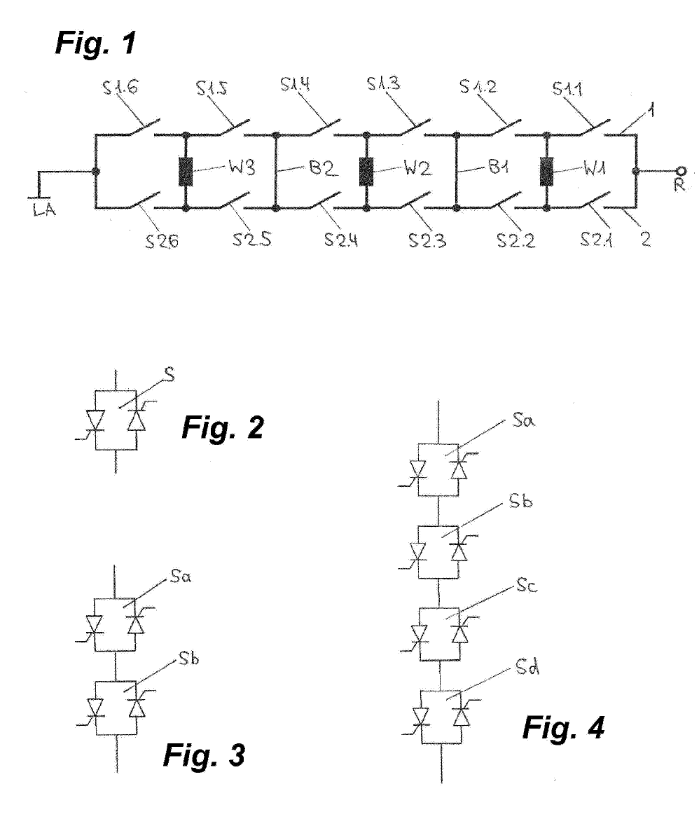

FIG. 1 shows a first form of embodiment of a tap changer according to the invention,

FIG. 2 shows a first semiconductor switching unit,

FIG. 3 shows a second semiconductor switching unit,

FIG. 4 shows a third semiconductor switching unit,

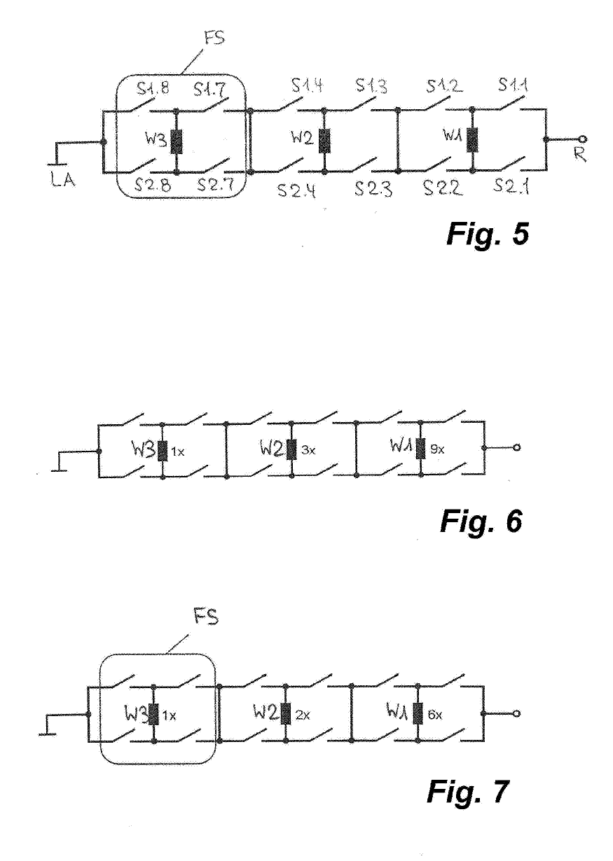

FIG. 5 shows a second form of embodiment of a tap changer according to the invention,

FIG. 6 shows a special dimensioning of the tap changer shown in FIG. 1 and

FIG. 7 shows a special dimensioning of the tap changer shown in FIG. 5.

FIG. 1 shows a first tap changer according to the invention. The tap changer shown here is arranged between the fixed, unregulated part of the regulating winding above the terminal R and the load diverter LA. It has two parallel load branches 1 and 2. Semiconductor switching units S1.1 to S1.6 are provided in the first load branch 1 in series connection. Further semiconductor switching units S2.1 to S2.6 are provided in the second load branch 2 similarly in series connection. In that case a respective semiconductor switching unit of the first load branch 1 and semiconductor switching unit of the second load branch 2 are opposite one another in pairs, namely the semiconductor switching units S1.1 and S2.1, S1.2 and S2.2, etc., to S1.6 and S2.6. Respective sub-windings W1, W2, W3 of the regulating winding and electrical bridges B1, B2, B3 are connected in parallel between the two load branches 1 and 2 respectively in alternation between these semiconductor switching units S1.1 and S2.1, S1.2 and S2.2, etc., to S1.6 and S2.6 opposite one another in pairs. In FIG. 1 it is shown that a first sub-winding W1 is connected between the semiconductor switching units S1.1 and S2.1 on the one hand and S1.2 and S2.2 on the other hand, a first electrical bridge B1 is connected between the semiconductor switching units S1.2 and S2.2 on the one hand and S1.3 and S2.3 on the other hand, a second sub-winding W2 is connected between the semiconductor switching units S1.3 and S2.3 on the one hand and S1.4 and S2.4 on the other hand, etc.

FIG. 2 shows a semiconductor switching unit that has, as semiconductor switch, a thyristor pair S in anti-parallel connection.

FIG. 3 shows a further semiconductor switching unit that has a series connection of two individual semiconductor switches Sa and Sb.

FIG. 4 shows a further semiconductor switching unit that has a series connection of four individual semiconductor switches Sa to Sd.

The individual semiconductor switches are here illustrated, by way of example, as thyristor pairs in anti-parallel connection; other known semiconductor switches, for example IGBTs, are also possible within the scope of the invention.

FIG. 5 shows a second form of embodiment of a tap changer according to the invention. In that case, a special switching subassembly FS is provided, comprising four special semiconductor switching units S1.7 and in series S1.8 in the first load branch 1 and S2.7 and in series therewith S2.8 in the second load branch 2, between which the one sub-winding W3 is arranged in parallel as described above. These special semiconductor switching units S1.7, S1.8, S2.7 and S2.8 are IGBTs that can be controlled by pulse width modulation (PWM) and thus allow a finely stepped switching-on and switching-off of the sub-winding W3. In this form of embodiment of the invention the sub-windings W1 and W2 are connected and connected in opposition as desired according to the respective switching state of the semiconductor switching units S1.1 to S1.4 and S2.1 to S2.4. The sub-winding W3 can be appropriately added or subtracted in any number of its parts that overall enables a particularly fine regulation without stepping.

FIG. 6 shows the tap changer of FIG. 1 with a particularly advantageous dimensioning. The position of the individual components corresponds with the illustration in FIG. 1, for which reason reference numerals were dispensed with for the sake of clarity. It is shown here that the first sub-winding W1 has nine times the winding number of the third sub-winding W3; the second sub-winding W2 has three times the winding number of the third sub-winding W3. In total 27 voltage steps can thus be produced in the illustrated example by selective connecting and disconnecting of the three sub-windings W1 to W3.

For example, the center setting ‘0’ is obtained with the tap changer according to the invention in that the semi-conductor switching units S1.1 to S1.6 are closed, whereas the semiconductor switching units S2.1 to S2.6 are opened. In redundant manner, the semiconductor switching units S1.1 to S1.6 can also be opened and the semiconductor switching units S2.1 to S2.6 closed. It can be seen that this setting, but not only this, can be produced in redundant manner.

In the case of the setting ‘13’ in which all sub-windings W1 to W3 are connected in the same sense, by way of example the following settings of the semiconductor switching units arise: S.1 closed, S1.2 open, S1.3 closed, S1.4 open, S1.5 closed, S1.6 open; S2.1 open, S2.2 closed, S2.3 open, S2.4 closed, S2.5 open, S2.6 closed. All other settings of the tap changer according to the invention, i.e. voltage steps, can be produced in entirely analogous manner.

In order to manage the corresponding switching outputs it can be advantageous to provide the individual semiconductor switching units respectively as a series connection of several separate semiconductor switches, as is shown, by way of example, in FIGS. 3 and 4.

FIG. 7 shows the tap changer of FIG. 5 with a similarly particularly advantageous dimensioning. The position of the individual components again corresponds with the illustration in FIG. 5, for which reason reference numerals were also dispensed with here for the sake of clarity. It is shown here that the first sub-winding W1 has nine times the winding number of third sub-winding W3; the second sub-winding W2 has twice the winding number of the third sub-winding W3. A finely stepped regulation is possible by selective connection and connection in opposition of the two sub-windings W1 and W2 and switching of the sub-winding W3 rapidly in terms of time. In order to manage the corresponding switching voltages, it can also be advantageous here to provide the semiconductor switching units respectively as a series connection of several separate semiconductor switches, as is shown, by way of example, in FIGS. 3 and 4.

Other dimensions of the sub-windings W1 to W3, as also the semiconductor switching units S1.1 to S2.8, are also possible within the scope of the invention.

1. A tap changer for voltage regulation, the tap changer comprising:
a regulating transformer with a regulating winding having a fixed unregulated part,
a load diverter;
semiconductor units at the regulating transformer, the tap changer being between the fixed, unregulated part of the regulating winding and the load diverter,
first and second parallel load branches,
semiconductor switching units in series connection in the first load branch,
further semiconductor switching units similarly in series connection in the second load branch in such a manner that each semiconductor switching unit of the first load branch and each semiconductor switching unit of the second load branch are opposite one another as a pair, and
respective sub-windings of the regulating winding and electrical bridges connected in parallel between the two load branches in alternation between the semiconductor switching units opposite one another in pairs.

2. The tap changer according to claim 1, wherein the sub-windings have different winding numbers.

3. The tap changer according to claim 1, wherein the individual semiconductor switching units consist of thyristor pairs in anti-parallel connection.

4. The tap changer according to claim 1, wherein at least one of the semiconductor switching units consists of a series connection of two or more individual semiconductor switches.

5. The tap changer according to claim 1, wherein at least one of the semiconductor switching units is controllable by a pulse width modulation.
